(19) United States
(12) Patent Application Publication
(10) Pub. No.: US 2026/0063811 A1
(43) Pub. Date: Mar. 5, 2026

(54) RADIATION DETECTOR MODULE, DEVICE, SYSTEM AND MANUFACTURING METHOD THEREOF

(71) Applicant: GE Precision Healthcare LLC, Waukesha, WI (US)

(72) Inventors: Dongmei Wang, Beijing (CN); Xinfeng Li, Beijing (CN); Qinglei Li, Beijing (CN); Yuwei Zhang, Beijing (CN)

(21) Appl. No.: 19/315,238

(22) Filed: Aug. 29, 2025

(30) Foreign Application Priority Data
Aug. 30, 2024 (CN) 202411210098.3
Aug. 30, 2024 (CN) 202422124518.8

(51) Int. Cl. G01T 1/20

(52) U.S. Cl. CPC G01T 1/20188; G01T 1/20181; G01T 1/20186

(57) ABSTRACT

Provided in the present disclosure are a radiation detector module and apparatus, a system, and a manufacturing method. The radiation detector module includes a stacked multilayer structure. The multilayer structure includes: a detector layer, configured to detect a ray that is incident on the detector layer and convert the ray into an electrical signal; a frame layer, wherein the detector layer is disposed on a first side of the frame layer facing a radiation source and is fixed to the frame layer; and a signal processing layer, disposed on a second side of the frame layer opposite to the first side and fixed to the frame layer, wherein the signal processing layer is configured to communicate with the detector layer to receive the electrical signal and process the electrical signal.

### CROSS-REFRENCE TO RELATED APPLICATIONS

This application claims priority to Chinese Application No. 202411210098.3, filed on August 30, 2024, and to Chinese Application No. 202422124518.8, filed August 30, 2024, the disclosures of which are incorporated herein by reference in their entirety.

### TECHNICAL FIELD

The present disclosure relates to the field of detection, and more particularly, to a radiation detector module, a radiation detector apparatus including the radiation detector module, a radiation detector system including the radiation detector apparatus, and a manufacturing method of the radiation detector module.

### BACKGROUND

A detection system (for example, an imaging system) may be configured to image an examination subject and obtain a corresponding detection result. For example, computed tomography (CT) systems are widely used in various medical institutions to perform three-dimensional imaging on a region of interest, such as the lung, of the examination subject, so as to aid clinicians in accurate medical diagnosis of the examination subject.

Some detection systems use rays emitted by a radiation source to irradiate the examination subject, and use a detector on the side opposite to the radiation source to perform detection, so as to further analyze data and obtain information of the examination subject. For example, the CT system uses X-rays emitted by an X-ray source to scan an examination subject (for example, a human body), receives the X-rays transmitted through the human body by using the detector, converts the X-rays into digital signals, and then forms images through computer processing and analysis to obtain, for example, images of one or a plurality of parts of the human body.

A radiation detector module is an important component of a CT imaging system. It is desirable for the radiation detector module to have a smaller dimension (for example, height or thickness) and lower costs. In addition, the radiation detector module plays a very important role in the quality and accuracy of images, and to achieve this objective, the radiation detector module should have thermal stability, and components included in the radiation detector module should generally be accurately aligned internally. In addition, other important requirements of a CT detector include ease of assembly, reliability, and the like.

### SUMMARY OF THE INVENTION

To resolve at least one or a plurality of the above technical problems and/or other possible technical problems, some embodiments of the present disclosure provide a radiation detector module, including a stacked multilayer structure. The multilayer structure includes a detector layer. The detector layer is configured to detect a ray that is incident on the detector layer and convert the ray into an electrical signal. The multilayer structure further includes a frame layer. The detector layer is disposed on a first side of the frame layer facing a radiation source and is fixed to the frame layer. The multilayer structure further includes a signal processing layer. The signal processing layer is disposed on a second side of the frame layer opposite to the first side and is fixed to the frame layer, wherein the signal processing layer is configured to communicate with the detector layer to receive the electrical signal and process the electrical signal.

Optionally, the frame layer includes a thermally conductive material. Optionally, the detector layer is attached to the frame layer by using a thermally conductive adhesive. Optionally, the detector layer, the frame layer, and the signal processing layer respectively have a flat-plate configuration and are parallel to each other. Optionally, at least part of a surface of the first side of the frame layer is covered with a radiation shielding layer. Optionally, a heater is mounted on a surface of the second side of the frame layer. In some embodiments, the surface of the second side of the frame layer includes a middle region and an edge region outside the middle region, and the heater is mounted in the middle region. Optionally, at least part of a surface of the heater is covered with a thermal insulation layer. The thermal insulation layer is configured to block thermal conduction between the frame layer and the heater. Optionally, a first heat sink is mounted on a surface of the second side of the frame layer. In some embodiments, the surface of the second side of the frame layer includes a middle region and an edge region outside the middle region, and the first heat sink is disposed on at least part of the edge region of the surface of the second side. Optionally, one or a plurality of connecting structures is/are comprised between the signal processing layer and the frame layer. In some embodiments, the one or the plurality of connecting structures includes/comprise one or a plurality of support pillars, gaskets, or supports disposed on the frame layer. Optionally, the detector layer includes an array of detector units or an integrated flat panel detector. Optionally, the radiation detector module further includes a flexible wiring board connecting the detector layer and the signal processing layer to transmit a signal, wherein the wiring board passes through or across the frame layer. Optionally, the signal processing layer includes a circuit board, and a second heat sink is mounted on the circuit board. Optionally, the multilayer structure of the radiation detector module further includes a housing layer. The housing layer at least partially covers the signal processing layer and is connected to the frame layer. Optionally, the signal processing layer includes a heat sink. The housing layer is provided with an opening for the heat sink to extend out of the housing layer.

Some embodiments of the present disclosure also provide a radiation detector apparatus, including one or a plurality of radiation detector modules as described above. Optionally, the radiation detector apparatus includes at least two radiation detector modules, and the at least two radiation detector modules are arranged on a same track. Optionally, the track includes an arc-shaped track. Some embodiments of the present disclosure further provide a radiation system. The radiation system includes the radiation detector apparatus as described in any of the above paragraphs. The radiation system further includes a radiation source. The radiation source is arranged to emit the ray toward the radiation detector apparatus.

Some embodiments of the present disclosure further provide a radiation detector. The radiation detector includes a detector circuit board. The detector circuit board includes a probe element that converts received ray radiation into an electrical signal. The radiation detector further includes a signal processing circuit board. The signal processing circuit board communicates with the detector circuit board and includes a signal processing circuit processing the electrical signal received from the detector circuit board. The radiation detector further includes a frame, wherein the detector circuit board and the signal processing circuit board are disposed on two sides of the frame along a ray radiation direction, respectively.

Optionally, the frame and the detector circuit board perform thermal conduction. Optionally, the frame includes a middle region covered by at least one of the detector circuit board and the signal processing circuit board. In some embodiments, the frame further includes an edge region extending out of the middle region, and the frame further includes a first heat sink mounted to the edge region. Optionally, the radiation detector includes a radiation shielding layer, disposed between the detector circuit board and the frame. Optionally, the radiation detector includes a heater, disposed between the signal processing circuit board and the frame. Optionally, the radiation detector includes a flexible wiring board, connecting the detector circuit board and the signal processing circuit board to transmit a signal. The wiring board passes through or across the frame. Optionally, the radiation detector includes a second heat sink, disposed on the signal processing circuit board and extending along the ray radiation direction. Optionally, the radiation detector includes a housing, covering the signal processing circuit board, wherein the housing includes an opening for a second heat sink to extend out of the housing.

Some embodiments of the present disclosure provide a method for manufacturing a radiation detector, including providing a detector circuit board, wherein the detector circuit board includes a probe element that converts received ray radiation into an electrical signal. The manufacturing method further includes providing a signal processing circuit board, and enabling the signal processing circuit board to communicate with the detector circuit board, wherein the processing circuit board includes a signal processing circuit processing the electrical signal received from the detector circuit board. The method further includes providing a frame, and disposing the detector circuit board and the signal processing circuit board on two sides of the frame along a ray radiation direction, respectively.

Optionally, the method includes enabling the frame and the detector circuit board to perform thermal conduction. Optionally, the method includes covering at least one of the detector circuit board and the signal processing circuit board in a middle region of the frame; and mounting a first heat sink to an edge region of the frame extending out of the middle region. Optionally, the method includes disposing a radiation shielding layer between the detector circuit board and the frame. Optionally, the method includes disposing a heater between the signal processing circuit board and the frame.

Optionally, the method includes connecting the detector circuit board and the signal processing circuit board by using a flexible wiring board to transmit a signal, wherein the wiring board passes through or across the frame. Optionally, the method includes disposing a second heat sink on the signal processing circuit board and arranging the second heat sink to extend along the ray radiation direction. Optionally, the method includes providing a housing covering the signal processing circuit board. In some embodiments, the housing includes an opening for the second heat sink to extend out of the housing.

### BRIEF DESCRIPTION OF THE DRAWINGS

In order to further describe embodiments of the present invention, the embodiments of the present invention will be presented in detail with reference to the accompanying drawings. It should be understood that these accompanying drawings may delineate only typical embodiments of the present invention, and thus will not be considered to limit the scope of protection claimed by the present invention.

In addition, the drawings show a main connection relationship or relative position relationship of each component, rather than all of these relationships, and the components and connections in the drawings are not necessarily drawn to scale in practice.

FIG. 1 shows an exemplary CT imaging system.

FIG. 2 is a block diagram of an exemplary imaging system similar to the CT imaging system in FIG. 1.

FIG. 3 is an exploded view of a radiation detector module according to some embodiments of the present disclosure.

FIG. 4 is an exploded view of a radiation detector module according to some other embodiments of the present disclosure.

FIG. 5 is an assembly view of the radiation detector module in FIG. 3 that does not include a housing according to some embodiments of the present disclosure.

FIG. 6 is an assembly view of the radiation detector module in FIG. 3 that includes a housing according to some embodiments of the present disclosure.

FIG. 7 is an assembly view of the radiation detector module in FIG. 4 that does not include a housing according to some other embodiments of the present disclosure.

FIG. 8 is an assembly view of the radiation detector module in FIG. 4 that includes a housing according to some other embodiments of the present disclosure.

FIG. 9 is a block diagram of a method for manufacturing a radiation detector according to some embodiments of the present disclosure.

### DETAILED DESCRIPTION

The following detailed description is provided with reference to the accompanying drawings. The accompanying drawings illustrate, via examples, specific embodiments capable of implementing the claimed subject matter. It should be understood that the following specific embodiments are intended to specifically describe typical examples for the purpose of explanation, but should not be understood as limiting the present invention. On the premise of fully understanding the spirit and gist of the present invention, a person skilled in the art can make appropriate modifications and adjustments to the disclosed embodiments without departing from the spirit and scope of the claimed subject matter of the present invention.

In the following detailed description, numerous specific details are set forth in order to provide a thorough understanding of the embodiments described. However, it will be apparent to those of ordinary skill in the art that the described various embodiments can be implemented without these specific details. In other examples, commonly-known structures are not described in detail to avoid unnecessarily obscuring aspects of the embodiments. Unless otherwise defined, terms used herein shall have the same meanings as commonly understood by those of ordinary skill in the art to which the present disclosure belongs.

The terms “first”, “second”, and the like, in the description and claims of the present disclosure do not denote any order, quantity, or importance, but are merely intended to distinguish between different constituents or features.

Embodiments of the present disclosure are exemplary implementations or examples. Reference in the description to “embodiments”, “one embodiment”, “some embodiments”, “alternative embodiments”, or “other embodiments” means that specific features and structures described with reference to embodiments are included in at least some embodiments of the present technology, but are not necessarily included in all embodiments. Various occurrences of “embodiments”, “one embodiment”, or “some embodiments” do not necessarily refer to the same embodiment. Elements or aspects from one embodiment may be combined with elements or aspects of another embodiment.

The term “and/or” in descriptions of the present disclosure describes only an association relationship between associated objects and represents that three relationships may exist. For example, A and/or B may indicate three situations, i.e., A exists alone, A and B exist simultaneously, or B exists alone. In addition, the character “/” in this specification generally indicates an “or” relationship between the associated objects.

Unless defined otherwise, technical terms or scientific terms used in the claims and description should have the usual meanings that are understood by those of ordinary skill in the technical field to which the present invention belongs. The terms “include” or “comprise” and similar words indicate that an element or object preceding the terms “include” or “comprise” encompasses elements or objects and equivalent elements thereof listed after the terms “include” or “comprise”, and do not exclude other elements or objects.

It should be understood that the description of the positions and directions in the present description is provided with reference to specific embodiments shown in the accompanying drawings, and is therefore a relative position description. In other embodiments where the placement direction of the device and apparatus is opposite or different than the direction shown in the drawings, these position descriptions may vary accordingly.

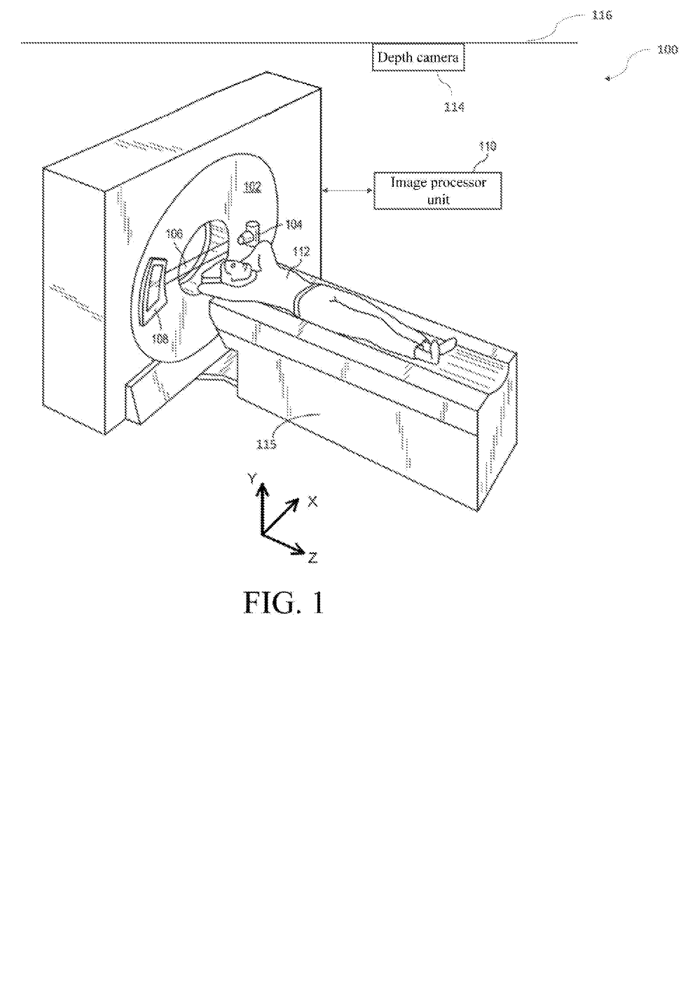

A radiation detector module, a radiation detector apparatus including the radiation detector module, a radiation detector system including the radiation detector apparatus, and a manufacturing method of the radiation detector module that may be used to practice the present invention are described in detail below with reference to FIG. 1 to FIG. 9.

Although in the present disclosure, a technology of the present invention is described in combination with a CT imaging apparatus, it should be understood that the technology of the present invention may also be applied to any other suitable type of imaging system, including but not limited to a baggage X-ray machine, various medical imaging systems, and the like. In addition to CT, the medical imaging systems may include other medical imaging modalities, such as a C-arm imaging system, a positron emission tomography (PET) system, a single photon emission computed tomography (SPECT) system, an interventional imaging system (such as angiography and biopsy), an X-ray radiation imaging system, an X-ray fluoroscopy imaging system, etc., and a combination thereof (for example, a multi-modality imaging system, such as a PET/CT or SPECT/CT imaging system). Different types of imaging systems are applicable for detection of corresponding objects. The object may be any type of suitable object. As an example, a baggage x-ray machine is suitable for detecting specific articles in baggage. For the medical imaging system, detectable objects include interventional objects (such as needles, endoscopes, implants, catheters, guide wires, dilators, ablators, contrast agents, etc.), lesions (such as tumors, etc.), bones, organ tissue structures, vascular structures, etc. In another aspect, for example, in addition to being used in the medical field, the CT imaging system may be used for, for example, part inspection and the like in the manufacturing industry.

FIG. 1 shows an exemplary CT imaging system 100. Specifically, the CT imaging system (also referred to as a CT apparatus) 100 is configured to image an examination subject 112 (such as a patient, an inanimate subject, one or a plurality of manufactured components, an industrial component, a foreign subject, or the like). Throughout the present disclosure, the terms “examination subject” and “patient” may be used interchangeably, and it should be understood that, at least in some embodiments, a patient is a type of examination subject that may be imaged by the CT imaging system 100, and that an examination subject may include a patient. In some embodiments, the CT imaging system 100 includes a gantry 102. The gantry 102 may include at least one X-ray radiation source 104. The at least one X-ray radiation source 104 is configured to project an X-ray beam (or X-ray) 106 for imaging the examination subject 112. Specifically, the X-ray radiation source 104 is configured to project the X-ray 106 toward a detector array 108 positioned on the opposite side of the gantry 102. Although FIG. 1 illustrates only one X-ray radiation source 104, in some embodiments, a plurality of X-ray radiation sources 104 may be used to project a plurality of X-rays 106 toward a plurality of detectors, so as to acquire projection data corresponding to the examination subject 112 at different energy levels.

In some embodiments, the X-ray radiation source 104 projects the fan-shaped or cone-shaped X-ray beam 106. The fan-shaped or cone-shaped X-ray beam 106 is collimated to be located in an x-y plane of a Cartesian coordinate system, and the plane is generally referred to as an “imaging plane” or a “scanning plane”. The X-ray beam 106 passes through the examination subject 112. The X-ray beam 106, after being attenuated by the examination subject 112, is incident on the detector array 108. The intensity of the attenuated radiation beam received at the detector array 108 depends on the attenuation of the X-ray 106 by the examination subject 112. Each detector element of the detector array 108 produces a separate electrical signal that serves as a measure of the intensity of the beam at the detector position. Intensity measurements from all detectors are separately acquired to generate a transmission distribution.

In third-generation CT imaging systems, the gantry 102 is used to rotate the X-ray radiation source 104 and the detector array 108 within the imaging plane around the examination subject 112, so that the angle at which the X-ray beam 106 intersects with the examination subject 112 is constantly changing. A full gantry rotation occurs when the gantry 102 completes a full 360-degree rotation. A set of X-ray attenuation measurements (e.g., projection data) from the detector array 108 at one gantry angle is referred to as a “view”. Thus, the view represents each incremental position of the gantry 102. A “scan” of the examination subject 112 includes a set of views made at different gantry angles or viewing angles during one rotation of the X-ray radiation source 104 and the detector array 108.

In an axial scan, projection data is processed to construct an image corresponding to a two-dimensional slice captured through the examination subject 112. A method for reconstructing an image from a set of projection data is referred to as a filtered back projection technique in the art. The method converts an attenuation measurement from a scan into an integer referred to as “CT number” or “Hounsfield unit” (HU), the integer being used to control, for example, the brightness of a corresponding pixel on a cathode ray tube display.

In some examples, the CT imaging system 100 may include a depth camera 114 positioned on or outside the gantry 102. As shown in FIG. 1, the depth camera 114 is mounted on a ceiling panel 116 positioned above the examination subject 112 and oriented to image the examination subject when the examination subject 112 is at least partially outside the gantry 102. The depth camera 114 may include one or more light sensors, including one or more visible light sensors and/or one or more infrared (IR) light sensors. In some implementations, the one or more IR sensors may include one or more sensors in a near-IR range and a far-IR range to implement thermal imaging. In some embodiments, the depth camera 114 may further include an IR light source. The light sensor may be any 3D depth sensor, such as a time-of-flight (ToF) sensor, a stereo sensor, or a structured light depth sensor, the 3D depth sensor being operable to generate a 3D depth image, while in other embodiments the light sensor may be a two-dimensional (2D) sensor operable to generate a 2D image. In some such implementations, a 2D light sensor may be used to infer a depth from knowledge of light reflection to estimate a 3D depth. Regardless of whether the light sensor is a 3D depth sensor or a 2D sensor, the depth camera 114 may be configured to output a signal for encoding an image to a suitable interface. The interface may be configured to receive, from the depth camera 114, the signal for encoding the image. In other examples, the depth camera 114 may further include other components, such as a microphone, so that the depth camera can receive and analyze directional and/or non-directional sound from the observed examination subject and/or other sources.

In some embodiments, the CT imaging system 100 further includes an image processing unit 110 configured to reconstruct an image of a target volume of a patient by using a suitable reconstruction method (such as an iterative or analytical image reconstruction method). For example, the image processing unit 110 may reconstruct an image of a target volume of a patient by using an analytical image reconstruction method (such as filtered back projection (FBP)). As another example, the image processing unit 110 may reconstruct an image of a target volume of a patient by using an iterative image reconstruction method (such as adaptive statistical iterative reconstruction (ASIR), conjugate gradient (CG), maximum likelihood expectation maximization (MLEM), model-based iterative reconstruction (MBIR), or the like).

As used herein, the phrase “reconstructing an image” is not intended to exclude an embodiment of the present invention in which data representing an image is generated rather than a viewable image. Thus, as used herein, the term “image” broadly refers to both a viewable image and data representing a viewable image. However, many embodiments generate (or are configured to generate) at least one viewable image.

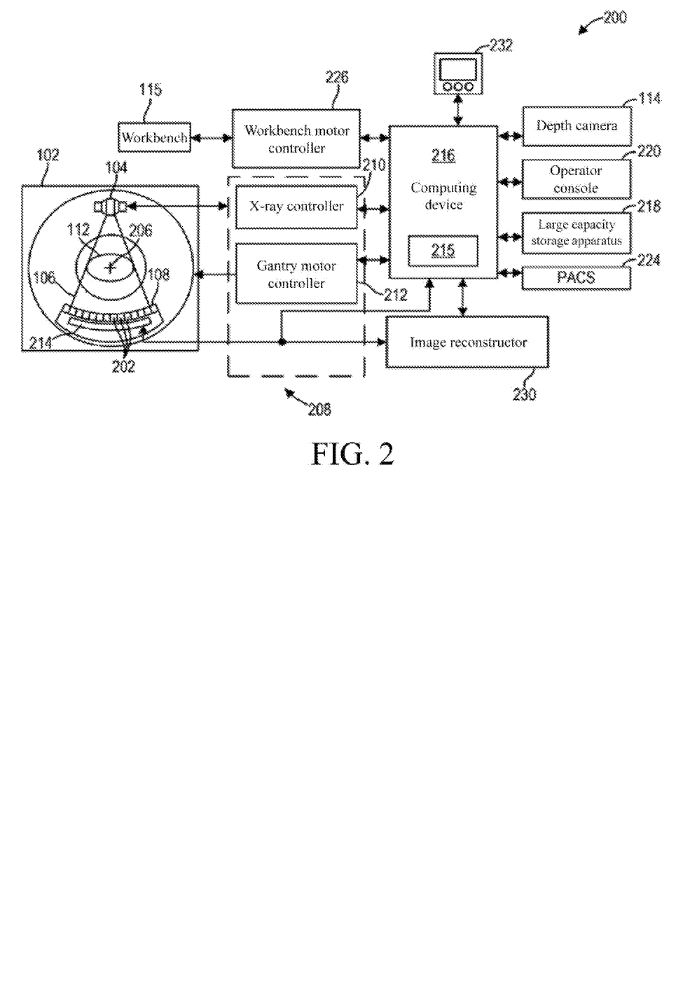

The CT imaging system 100 further includes a workbench 115, and the examination subject 112 is positioned on the workbench 115 to facilitate imaging. The workbench 115 may be electrically powered, so that a vertical position and/or a lateral position of the workbench can be adjusted. Accordingly, the workbench 115 may include a motor and a motor controller, as will be explained below with respect to FIG. 2. The workbench motor controller moves the workbench 115 by adjusting the motor, so as to properly position the examination subject in the gantry 102 to acquire projection data corresponding to a target volume of the examination subject. The workbench motor controller may adjust the height of the workbench 115 (e.g., a vertical position relative to a floor on which the workbench is located) and a lateral position of the workbench 115 (e.g., a horizontal position of the workbench along an axis parallel to an axis of rotation of the gantry 102).

FIG. 2 shows an exemplary imaging system 200 similar to the CT imaging system 100 in FIG. 1. In some embodiments, the imaging system 200 includes the detector array 108 (see FIG. 1). The detector array 108 further includes a plurality of detector elements 202. The plurality of detector elements together collect the X-ray beam 106 (see FIG. 1) passing through the examination subject 112 to acquire corresponding projection data. Therefore, in some embodiments, the detector array 108 is fabricated in a multi-slice configuration including a plurality of rows of units or detector elements 202. In such configurations, one or more additional rows of detector elements 202 are arranged in a parallel configuration for acquiring projection data. In some examples, an individual detector in the detector array 108 or the detector elements 202 may include a photon counting detector that registers interactions of individual photons into one or more energy bins. It should be understood that the methods described herein may also be implemented using an energy integration detector.

In some embodiments, the imaging system 200 is configured to traverse different angular positions around the examination subject 112 to acquire required projection measurement data. Therefore, the gantry 102 and components mounted thereon can be configured to rotate about a center of rotation 206 to acquire, for example, projection measurement data at different energy levels. Alternatively, in embodiments in which a projection angle with respect to the examination subject 112 changes over time, the mounted components may be configured to move along a substantially curved line rather than a segment of a circumference.

In some embodiments, the imaging system 200 includes a control mechanism 208 to control the movement of the components, such as the rotation of the gantry 102 and the operation of the X-ray radiation source 104. In some embodiments, the control mechanism 208 further includes an X-ray controller 210, configured to provide power and timing signals to the X-ray radiation source 104. Additionally, the control mechanism 208 includes a gantry motor controller 212, configured to control the rotational speed and/or position of the gantry 102 on the basis of imaging requirements.

In some embodiments, the control mechanism 208 further includes a data acquisition system (DAS) 214, configured to sample analog data received from the detector elements 202, and convert the analog data to a digital signal for subsequent processing. The data sampled and digitized by the DAS 214 is transmitted to a computer or computing device 216. In an example, the computing device 216 stores data in a storage apparatus 218. For example, the storage apparatus 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In some implementations, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows only one operator console 220, more than one operator console may be coupled to the imaging system 200, for example, for inputting or outputting system parameters, requesting examination, and/or viewing images. Moreover, in some embodiments, the imaging system 200 may be coupled to, for example, a plurality of displays, printers, workstations, and/or similar devices located locally or remotely within an institution or hospital or in a completely different location by means of one or more configurable wired and/or wireless networks (such as the Internet and/or a virtual private network).

In some embodiments, for example, the imaging system 200 includes or is coupled to a picture archiving and communication system (PACS) 224. In one exemplary embodiment, the PACS 224 is further coupled to a remote system (such as a radiology information system or a hospital information system), and/or an internal or external network (not shown) to allow operators in different locations to provide commands and parameters and/or acquire access to image data.

The computing device 216 uses operator-provided and/or system-defined commands and parameters to operate a workbench motor controller 226, which can in turn control a workbench motor, thereby adjusting the position of the workbench 115 shown in FIG. 1. Specifically, the workbench motor controller 226 moves the workbench 115 by means of the workbench motor, so as to properly position the examination subject 112 in the gantry 102 to acquire projection data corresponding to a target volume of the examination subject 112. For example, the computing device 216 may send a command to the workbench motor controller 226 to instruct the workbench motor controller 226 to adjust the vertical position and/or the lateral position of the workbench 115 by means of the motor.

As described previously, the DAS 214 samples and digitizes the projection data acquired by the detector elements 202. Subsequently, an image reconstructor 230 uses the sampled and digitized X-ray data to perform high-speed reconstruction. Although the image reconstructor 230 is shown as a separate entity in FIG. 2, in some embodiments, the image reconstructor 230 may form a part of the computing device 216. Alternatively, the image reconstructor 230 may not be present in the imaging system 200, and the computing device 216 may instead perform one or more functions of the image reconstructor 230. In addition, the image reconstructor 230 may be located locally or remotely and may be operably connected to the imaging system 200 by using a wired or wireless network. Specifically, in one exemplary embodiment, computing resources in a “cloud” network cluster are available to the image reconstructor 230.

In some embodiments, the image reconstructor 230 stores the reconstructed image in the storage apparatus 218. Alternatively, the image reconstructor 230 transmits the reconstructed image to the computing device 216 to generate usable examination subject information (also referred to as examination subject information) for diagnosis and evaluation. In some embodiments, the computing device 216 transmits the reconstructed images and/or examination subject information to a display 232, and the display is communicatively coupled to the computing device 216 and/or the image reconstructor 230. In some embodiments, the display 232 allows an operator to evaluate an imaged anatomical structure. The display 232 may further allow the operator to select a volume of interest (VOI) and/or request examination subject information by means of, for example, a graphical user interface (GUI) for subsequent scanning or processing.

As described further herein, the computing device 216 may include computer-readable instructions, and the computer-readable instructions are executable to send, according to an examination imaging scheme, commands and/or control parameters to one or more of the DAS 214, the X-ray controller 210, the gantry motor controller 212, and the workbench motor controller 226. The examination imaging scheme includes a clinical task/intent, also referred to herein as a clinical intent identifier (CID) of the examination. For example, the CID may inform a goal (e.g., a general scan or lesion detection, an anatomical structure of interest, a quality parameter, or another goal) of the procedure on the basis of a clinical indication, and may further define the position and orientation (e.g., posture) of the examination subject required during a scan (e.g., supine and feet first). The operator of the system 200 may then position the examination subject on the workbench according to the examination subject position and orientation specified by the imaging scheme. Further, the computing device 216 may set and/or adjust various scan parameters (e.g., a dose, a gantry rotation angle, kV, mA, an attenuation filter) according to the imaging scheme. For example, the imaging scheme may be selected by the operator from a plurality of imaging schemes stored in a memory on the computing device 216 and/or a remote computing device, or the imaging scheme may be automatically selected by the computing device 216 according to received examination subject information.

During the examination/scanning phase, it may be desirable to expose the examination subject to a radiation dose as low as possible while still maintaining the required the quality of images. In addition, reproducible and consistent imaging quality between examinations and between examination subjects, as well as between different imaging system operators, may be required. Thus, an imaging system operator may manually adjust the position of the workbench and/or the position of the examination subject, so as to, for example, center a desired anatomical structure of a patient at the center of a gantry bore. However, such a manual adjustment may be error-prone. Therefore, the CID associated with the selected imaging scheme may be mapped to various positioning parameters of the examination subject. The positioning parameters of the examination subject include the posture and orientation of the examination subject, the height of the workbench, an anatomical reference for scanning, and a starting and/or ending scan position.

Thus, the depth camera 114 may be operably and/or communicatively coupled to the computing device 216 to provide image data to determine the anatomy of the examination subject, including the posture and orientation. Additionally, various methods and procedures described further herein for determining the patient anatomy on the basis of image data generated by the depth camera 114 may be stored as executable instructions in a non-transitory memory of the computing device 216.

Additionally, in some examples, the computing device 216 may include a camera image data processor 215 that includes instructions for processing information received from the depth camera 114. The information (which may include depth information and/or visible light information) received from the depth camera 114 may be processed to determine various parameters of the examination subject, such as the identity of the examination subject, the physique (e.g., the height, weight, and patient thickness) of the examination subject, and the current position of the examination subject relative to the workbench and the depth camera 114. For example, prior to imaging, the body contour or anatomy of the examination subject 112 may be estimated by using images reconstructed from point cloud data, and the point cloud data is generated by the camera image data processor 215 according to images received from the depth camera 114. The computing device 216 may use these parameters of the examination subject to perform, for example, patient-scanner contact prediction, scan range superposition, and scan key point calibration, as will be described in further detail herein. Further, data from the depth camera 114 may be displayed by means of the display 232.

In some embodiments, information from the depth camera 114 may be used by the camera image data processor 215 to perform tracking of one or a plurality of examination subjects in the field of view of the depth camera 114. In some examples, skeleton tracking may be performed by using image information (e.g., depth information), in which a plurality of joints of the examination subject are identified and analyzed to determine the motion, posture, position, etc. of the examination subject. The positions of joints during the skeleton tracking can be used to determine the above-described parameters of the examination subject. In other examples, the image information may be directly used to determine the above-described parameters of the examination subject without skeleton tracking.

On the basis of these positioning parameters of the examination subject, the computing device 216 may output one or a plurality of alerts to the operator regarding patient posture/orientation and examination (e.g., scan) result prediction, thereby reducing the possibility that the examination subject is exposed to a higher than desired radiation dose and improving the quality and reproducibility of the image generated by the scan. As an example, the estimated body structure may be used to determine whether the examination subject is in an imaging position specified by the radiologist, thereby reducing the incidence of repeating the scan due to improper positioning. Furthermore, the amount of time an imaging system operator spends positioning the examination subject can be reduced, allowing more scans to be performed per day and/or allowing additional interaction with the examination subject.

A plurality of exemplary patient orientations may be determined on the basis of data received from a depth camera (such as the depth camera 114 described in FIG. 1 and FIG. 2). For example, a controller (e.g., the computing device 216 in FIG. 2) may perform patient structure extraction and posture estimation on the basis of an image received from the depth camera 114, thereby enabling different patient orientations to be distinguished from each other.

The CT imaging system 100 may perform imaging examination on the basis of a scanning protocol. The scanning protocol is a description of the imaging examination. The scanning protocol may include a description of an involved body part, for example, a medical or colloquial term for the body part. The scanning protocol may provide various parameters and related information for performing scans and post-processing, such as a power value, the duration of radiation, speed of movement, radiation energy, and a time delay between image captures, etc. It is conceivable that any configurable technical parameter that should be used for imaging examination by the imaging system 110 may be defined in the scanning protocol.

The CT imaging system 100 may have an automatic patient positioning function. That is, a patient may be automatically positioned in a scan start position in an opening of the gantry 102 on the basis of an examination instruction or the scanning protocol, and moved in the Z-axis direction to a scan end position during scanning and imaging. A conventional automatic patient positioning function may automatically determine the scan range in the horizontal direction on the basis of the anatomical structure to be imaged (e.g., from an examination instruction or the scanning protocol) and the patient structure from the depth camera 114, but the automatic centering thereof can only be substantially for the head or the body and the average body contour center of all scout scan ranges, so the precision of centering for particular anatomical structures and special patients is not good enough.

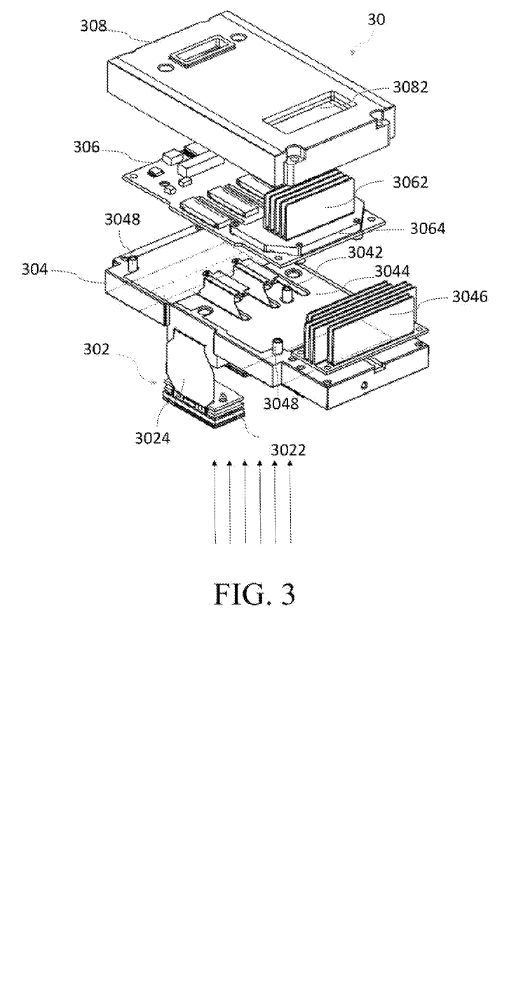

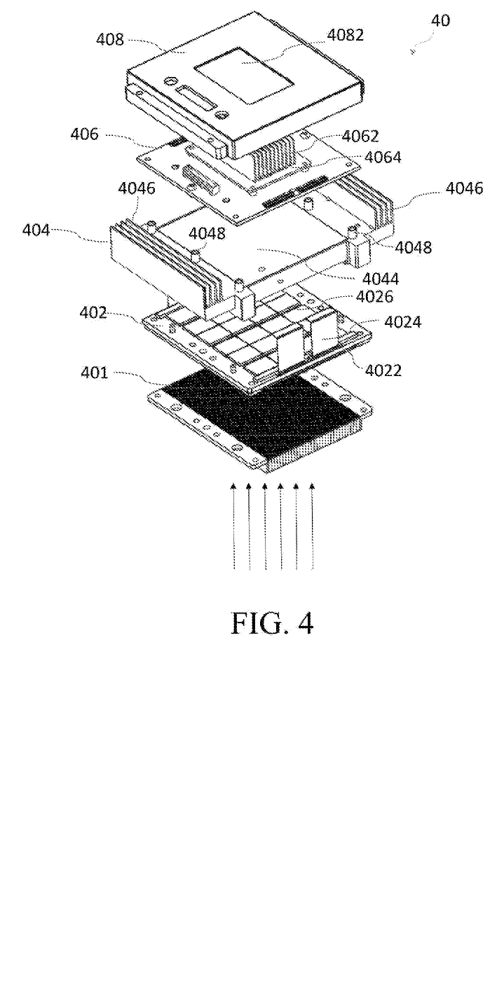

FIG. 3 is an exploded view of a radiation detector module 30 according to some embodiments of the present disclosure. FIG. 4 is an exploded view of a radiation detector module 40 according to some other embodiments of the present disclosure. In some embodiments of the present disclosure, the radiation detector module 30 or the radiation detector module 40 may be, for example, the detector element 102 described above in combination with FIG. 2, but the radiation detector module 30 in FIG. 3 and the radiation detector module 40 in FIG. 4 integrate functions of signal detection, analog-to-digital conversion, signal processing, and the like. Radiation rays, such as X-rays and the like, incident from below the radiation detector module 30 or the radiation detector module 40 are illustrated with arrows in FIG. 3 and FIG. 4, respectively, to indicate directions for description. To save the number of drawings and ease of description, respective layers included in the radiation detector module 30 or the radiation detector module 40 are illustrated in embodiments of FIG. 3 and FIG. 4. However, it should be understood that the radiation detector module 30 or the radiation detector module 40 may include a layer structure included in any of the embodiments described below, and does not necessarily include all of the layers shown in FIG. 3 and FIG. 4.

The radiation detector module 30 or 40 according to some embodiments of the present disclosure includes a stacked multilayer structure as shown in FIG. 3 or FIG. 4. The multilayer structure of the radiation detector module 30 includes a detector layer 302, a frame layer 304, and a signal processing layer 306. The detector layer 302 is disposed on a first side of the frame layer 304 facing a radiation source (e.g., the radiation source 104 in FIG. 1 or FIG. 2), that is, as shown in combination with FIG. 3, the detector layer 302 may be disposed below the frame layer 304. The signal processing layer 306 is disposed on a second side of the frame layer 304 opposite to the first side, that is, as shown in combination with FIG. 3, the signal processing layer 306 may be disposed above the frame layer 304. In other words, the detector layer 302 and the signal processing layer 306 are disposed on two sides of the frame layer 304 along a ray radiation direction (the direction indicated by the arrows), respectively. In some embodiments, the detector layer 302 and the signal processing layer 306 may be fixed to the frame layer 304. For example, the detector layer 302 and the signal processing layer 306 may be fixed to the frame layer 304 by using one or a plurality of mechanical structures, including but not limited to screws and the like.

Similarly, as shown in combination with FIG. 4, the multilayer structure of the radiation detector module 40 includes a detector layer 402, a frame layer 404, and a signal processing layer 406. The detector layer 402 is disposed on a first side of the frame layer 404 facing a radiation source, that is, as shown in combination with FIG. 4, the detector layer 402 may be disposed below the frame layer 404. The signal processing layer 406 is disposed on a second side of the frame layer 404 opposite to the first side, that is, as shown in combination with FIG. 4, the signal processing layer 406 may be disposed above the frame layer 404. In other words, the detector layer 402 and the signal processing layer 406 are disposed on two sides of the frame layer 404 along a ray radiation direction (the direction indicated by the arrows), respectively. In some embodiments, the detector layer 402 and the signal processing layer 406 may be fixed to the frame layer 404. For example, the detector layer 402 and the signal processing layer 406 may be fixed to the frame layer 404 by one or a plurality of mechanical structures, including but not limited to screws and the like.

The detector layers 302 and 402 may be configured to detect a ray that is incident on the detector layers 302 and 402, for example, a ray indicated by the arrows in FIG. 3 and FIG. 4. The detector layers 302 and 402 may be configured to further convert the detected ray into an electrical signal. In some embodiments of the present disclosure, the detector layers 302 and 402 may be implemented as circuit boards. A detector circuit board includes a probe element that converts received ray radiation into an electrical signal. In some embodiments, the ray may include an X-ray. In some embodiments, the probe element of the detector circuit board may include an element (e.g., a scintillator) that first converts the X-ray into visible light, and an element (e.g., a photodiode) that further converts the light into an electrical signal. In some embodiments, the probe element of the detector circuit board may include a photon-counting probe element or another type of element that directly converts the X-ray into an electrical signal. The detector circuit board may further include an analog-to-digital conversion circuit to convert an analog signal into a digital signal.

In the embodiment shown in FIG. 3, the detector layer 302 may include an array of a plurality of detector units 3022. As an example, the exploded view of FIG. 3 shows several detector units 3022, and these detector units 3022 may be reversely mounted to the bottom, i.e., the lower surface, of the frame layer 304. The detector layer 302 may include a number of detector units 3022 other than the number shown in FIG. 3. In the embodiment shown in FIG. 4, the detector layer 302 is formed by an integrated flat panel detector circuit board.

The signal processing layers 306 and 406 are configured to communicate with the detector layers 302 and 402 to receive the electrical signals converted by the detector layers 302 and 402 and process the electrical signals. In some embodiments of the present disclosure, the signal processing layers 306 and 406 may be implemented as circuit boards. A signal processing circuit board may communicate with the detector circuit board described above and include a signal processing circuit configured to process the electrical signal received from the detector circuit board.

In the technical solution of the present disclosure, functional modules are arranged in layers along a ray direction, and the frame layer is used to support the detector layer and the signal processing layer, so that the radiation detector module is more compact in dimension and easy to assemble.

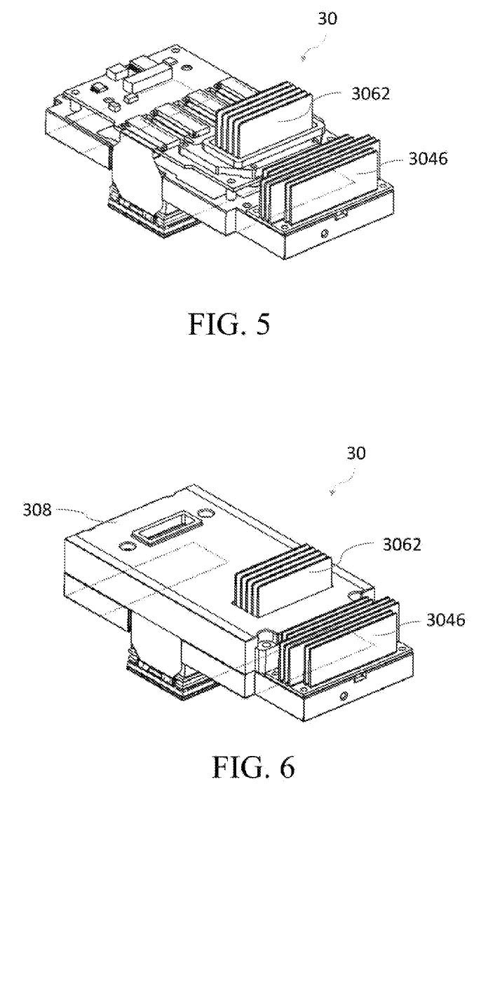

In the technical solution of the present disclosure, as shown in FIG. 3 and FIG. 4, the detector layers 302 and 402, the frame layers 304 and 404, and the signal processing layers 306 and 406 of the radiation detector modules 30 and 40 each have a flat-plate configuration and are parallel to each other. Accordingly, the radiation detector modules 30 and 40 as a whole are also in a flat-plate configuration, as shown in FIG. 5 to FIG. 8. The flat-plate configuration means that the dimensions of the radiation detector modules 30 and 40 and layer structures 302, 402, 304, 404, 306, and 406 thereof in a radiation receiving plane for receiving a ray or facing the radiation source are much larger or several times larger than the dimensions of the radiation detector modules 30 and 40 parallel to a propagation path of the ray. For example, as shown in FIG. 3 and FIG. 4, the detector layers 302 and 402, the frame layers 304 and 404, and the signal processing layers 306 and 406 are of thin rectangular cuboids, and the length and width thereof are each much greater than the height or thickness thereof. The radiation detector modules 30 and 40 and the layer structures 302, 402, 304, 404, 306, and 406 each have a flat-plate configuration. There is a large area to allow a single radiation detector module 30 or 40 to carry more detector units 3022 and 4022, that is, to increase the density of the radiation detector modules 30 and 40, accordingly to reduce manufacture costs of the radiation detector modules 30 and 40. In addition, the detector layers 302 and 402, the frame layers 304 and 404, and the signal processing layers 306 and 406 are parallel to each other, so that the height or thickness dimension of the radiation detector modules 30 and 40 can be reduced.

In some embodiments of the present disclosure, the frame layers 304 and 404 may be further configured for alignment of the detector layers 302 and 402 and the signal processing layers 306 and 406. As shown in FIG. 3, for example, the frame layer 304 allows the detector layer 302 and the signal processing layer 306 on two sides of the frame layer to be at least partially aligned, so as to facilitate signal transmission and facilitate reduction of the overall dimension of the radiation detector module 30. Similarly, as shown in FIG. 4, the frame layer 404 allows the detector layer 402 and the signal processing layer 406 on two sides of the frame layer to be at least partially aligned, so as to facilitate signal transmission and facilitate reduction of the overall dimension of the radiation detector module 40.

In the embodiment shown in FIG. 3, a flexible wiring board 3024 is further included. The flexible wiring board 3024 is configured to connect the detector units 3022 of the detector layer 302 and a corresponding signal processing circuit in the signal processing layer 306 to transmit a signal. Correspondingly, the frame layer 304 may include a slot 3042 that allows the flexible wiring board 3024 to pass through, so that the flexible wiring board 3024 passes through the slot 3042 of the frame layer 304 and is connected to the processing circuit layer 306 above the frame layer 304.

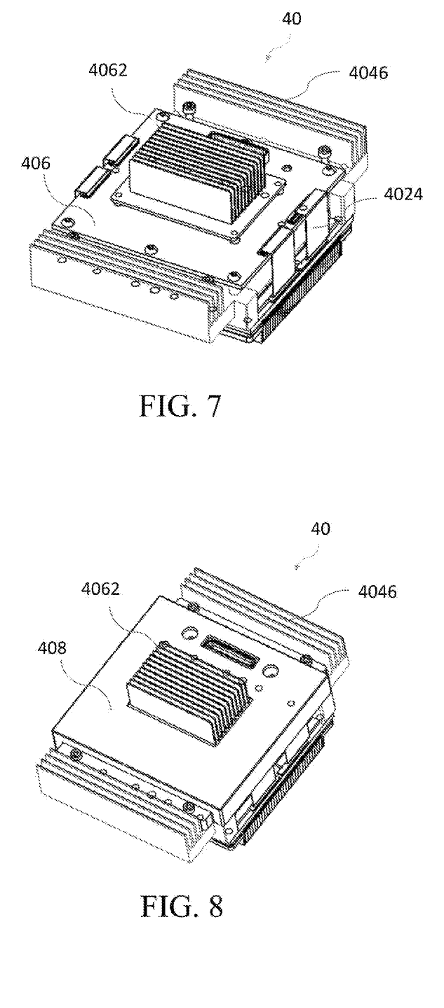

In the embodiment shown in FIG. 4, similarly, a flexible wiring board 4024 is included. As shown in an assembly view of FIG. 7, the flexible wiring board 4024 may be connected to the signal processing layer 406 across the frame 404 to transmit a signal to the signal processing layer 406. One or a plurality of flexible wiring boards 4024 may be included according to actual needs. As shown in FIG. 4, the flexible wiring board 4024 may extend from one or a plurality of edges of the detector layer 402 (for example, the detector circuit board) and extend in a direction (upward) toward the signal processing layer 406.

The detector layers 302 and 402 are important components for the radiation detector module and the imaging system, receive and detect an incident ray, and convert the ray into an electrical signal. Detectors in the detector layers 302 and 402 are very sensitive to temperature during operation. This property makes the thermal stability of the detector layers 302 and 402 very important for the quality and accuracy of the images ultimately obtained by the imaging system. In some embodiments of the present disclosure, the frame layers 304 and 404 may be further integrated with a temperature adjustment function to make the operating temperature of the radiation detector modules 30 and 40 more stable. In some embodiments of the present disclosure, the frame layers 304 and 404 are integrated with at least one of a heating or heat dissipation function.

A heater may be mounted on each of the frame layers 304 and 404. For example, as shown in FIG. 3, a heater 3044 is mounted on a surface (an upper surface) of the second side of the frame layer 304. For another example, as shown in FIG. 4, a heater 4044 is mounted on a surface (an upper surface) of the second side of the frame layer 404. In some embodiments, as shown in FIG. 3 and FIG. 4, the upper surfaces of the frame layers 304 and 404 each include a middle region and an edge region outside the middle region, and the heaters 3044 and 4044 may be mounted in the middle region.

In some embodiments of the present disclosure, the heaters 3044 and 4044 may be implemented as surface heaters with a thin thickness as shown in FIG. 3 and FIG. 4, so as to fully utilize the lateral (perpendicular to the direction shown by the arrows) space of the radiation detector modules 30 and 40 while achieving effective heating, thereby further reducing the dimensions of the radiation detector modules, especially the dimensions along the ray direction (that is, the heights or thicknesses of the radiation detector modules 30 and 40). In some embodiments, switching circuits coupled to the heaters 3044 and 4044 and configured to control the operating state of the heaters 3044 and 4044 may be included to turn on the heaters 3044 and 4044 for heating when needed (for example, when the operating environment temperature of the radiation detector modules 30 and 40 is lower than a preset value). In some embodiments of the present disclosure, at least part of the surfaces of the heaters 3044 and 4044 may be covered with thermal insulation layers. The thermal insulation layers may block thermal conduction between the frame layers and the heaters 3044 and 4044. The thermal insulation layer may be made of an insulation material, or the thermal insulation layer may be a gap between the frame layers and the heaters 3044 and 4044, and the air in the gap also serves as a barrier to thermal conduction.

Alternatively or additionally, the frame layers 304 and 404 may each be provided with a heat sink. For example, as shown in FIG. 3, a heat sink 3046 is mounted on the surface (the upper surface) of the second side of the frame layer 304, and the heat sink 3046 is a component and part independent of the frame layer 304. For another example, as shown in FIG. 4, a heat sink 4046 is mounted or disposed on the surface (the upper surface) of the second side of the frame layer 404. In some embodiments, as shown in FIG. 4, the frame layer 404 is an integrated mechanism manufactured by using a technology such as 3D printing or additive manufacturing, and the frame layer 404 is integrally provided with several sheet-shaped heat sinks 4046. In some embodiments, as shown in FIG. 3 and FIG. 4, the upper surfaces of the frame layers 304 and 404 each include a middle region and an edge region outside the middle region, and the heat sinks 3046 and 4046 may be disposed on at least part of the edge region of the upper surface of the frame layer 404. In some embodiments, as shown in FIG. 3, the heat sink 3046 may be disposed near one side edge of the upper surface of the frame layer 304. In some other embodiments, as shown in FIG. 4, heat sinks 4046 may be respectively disposed near two side edges of the upper surface of the frame layer 404.

In some embodiments of the present disclosure, the heat sinks 3046 and 4046 may be implemented in sheet shapes or fin shapes as shown in FIG. 3 and FIG. 4. The heat sinks 3046 and 4046 may each include a plurality of sheet-shaped or fin-shaped structures to increase the surface area and thus increase the heat dissipation speed. The sheet-shaped structures of the heat sinks 3046 and 4046 may extend at least partially along the edges and extend along the ray direction (the direction indicated by the arrows) to achieve good heat dissipation and make full use of the space of the radiation detector modules 30 and 40.

In some embodiments, the frames 304 and 404 may be made of a thermally conductive material to conduct heat. The thermally conductive material may enable heat generated by the heaters 3044 and 4044 to be conducted away faster, for example, conducted to the detectors of the detector layers 302 and 402 that performs thermal conduction with the frames. The thermally conductive material may also enable faster conduction of heat to the frame layers 304 and 404. Thus, the frames 304 and 404 may, in combination with the heaters 3044 and 4044 and/or the heat sinks 3046 and 4046, further promote thermal stability of the radiation detector modules 30 and 40, so that the imaging system can obtain higher quality, higher accuracy data. In some embodiments, the thermally conductive material of the frames 304 and 404 may include a conductor with good thermal conductivity, including but not limited to aluminum, copper, and the like.

In some embodiments, as shown in FIG. 4, the detector layer 402 includes a lower surface (not shown) facing the ray and an upper surface opposite to the lower surface along the ray direction. A probe element 4022 is mounted on the lower surface of the detector layer 402. As described above, in some embodiments, the probe element may include a scintillator, a photoelectric conversion diode, a photon-counting probe element, or another type of element that directly converts the X-ray into an electrical signal. A signal processing element 4026 is mounted on the upper surface of the detector layer 402, and the signal processing element 4026 may include an analog-to-digital conversion (ADC) chip that converts analog signals generated by the probe element into digital signals for subsequent signal processing and image reconstruction. At least part of the upper surface of the detection layer 402 may be provided with a thermally conductive adhesive. The thermally conductive adhesive may better fix the detector layer 402 with the frame layer 404. In addition, the thermally conductive adhesive may further promote the thermal conduction between the detector layer 402 and the frame layer 404. In some embodiments, the upper surface of the detection layer 402 may not be provided with the thermally conductive adhesive, that is, the detection layer 402 and the frame layer 404 are directly in contact and perform thermal conduction.

In some embodiments of the present disclosure, the signal processing layers 306 and 406 and the frame layers 304 and 404 are connected in an isolating manner to avoid electrical short circuit or interference. For example, in the embodiments shown in FIG. 3 and FIG. 4, a certain spacing distance may be provided between the signal processing layers 306 and 406 and the frame layers 304 and 404 by using support pillars 3048 and 4048, so as to implement an isolating connection between the signal processing layer 406 and the frame layer 404. In some other embodiments, an isolation design such as a gasket or a support may be used to implement the isolating connection between the signal processing layer 406 and the frame layer 404.

Because the signal processing layers 306 and 406 each include one or a plurality of components for signal processing, these components may generate heat during operation. To prevent or at least mitigate the heat generated by the signal processing layers 306 and 406 from being conducted directly to the frame layers 304 and 404, interfering with the temperature control of the frame layers 304 and 404 (which may in turn affect the temperature of the detector layers 302 and 402), therefore, in some embodiments of the present disclosure, the spacing design as described above is used between the signal processing layers 306 and 406 and the frame layers 304 and 404. In addition, the signal processing layers 306 and 406 each may further include heat sinks 3062 and 4062 to further avoid or reduce thermal interference of the signal processing layers 306 and 406 with the frame layers 304 and 404. The heat sinks 3062 and 4062 may be arranged at or near components where the heat generation is high, to more quickly conduct away the generated heat through the heat sinks 3062 and 4062, causing the temperature of the signal processing layers 306 and 406 to drop. In some embodiments of the present disclosure, the heat sinks 3062 and 4062 may be configured to extend along the ray radiation direction (the direction indicated by the arrows), so as to facilitate heat dissipation and fully utilize the longitudinal space, which is beneficial to reduce the dimension of the radiation detector module.

In some embodiments, the heat sinks 3062 and 4062 may also include one or a plurality of sheet-shaped or fin-shaped structures arranged side by side to increase a heat dissipation area and speed up the heat dissipation. In some embodiments, thermally conductive adhesives 3064 and 4064 may be included between the heat sinks 3062 and 4062 and the circuit boards 306 and 406. The thermally conductive adhesives 3064 and 4064 may be used to fix the heat sinks 3062 and 4062 to the circuit boards 306 and 406. The thermally conductive adhesives 3064 and 4064 may also accelerate the conduction of heat generated by the circuit boards 306 and 406 to the heat sinks 3062 and 4062.

In some embodiments of the present disclosure, a radiation shielding layer may be included between the detector layers 302 and 402 and the frame layers 304 and 404. For example, at least part of the lower surface of the frame layers 304 and 404 is covered with a radiation shielding layer. The radiation shielding layer is configured to prevent radiation rays from propagating upwards, that is, prevent radiation rays from propagating to the signal processing layer or the circuit boards 306 and 406. In some embodiments, the radiation shielding layer may be made of a high-density material such as tungsten, molybdenum, or lead. In some embodiments, the radiation shielding layer may be attached or coated to the lower surface of the frame layers 304 and 404.

In some embodiments of the present disclosure, as shown in FIG. 4, the radiation detector module 40 may further include a collimator layer 401. The collimator layer 401 is provided on the lower surface side of the detector layer 402. The collimator layer 401 may be fixed with the detector layer 402 and further to the frame layer 404. The collimator layer 401 may be attached to the lower surface of the detector layer 402. The collimator layer 401 may include a collimator for collimating or homogenizing radiation ray, preventing or reducing scattering of radiation rays. A collimator is made as an integrated structure by using 3D printing or additive manufacturing techniques to reduce manufacture costs and improve performance. The collimator has a flat-plate configuration, which may reduce the height or thickness of the radiation detector module 40. In other embodiments, the collimator layer 401 may alternatively be assembled to a guide rail or track for mounting the detector array 108 as shown in FIG. 2 according to design needs.

As shown in the exploded views of FIG. 3 and FIG. 4, in some embodiments of the present disclosure, the stacked multilayer structure in the radiation detector modules 30 and 40 may further include housing layers 308 and 408. In combination with FIG. 5 to FIG. 8, FIG. 5 and FIG. 6 are assembly views of the radiation detector module 30 in FIG. 3 that does not include a housing and that includes a housing, respectively, and FIG. 7 and FIG. 8 are assembly views of the radiation detector module 40 of FIG. 4 that does not include a housing and that includes a housing, respectively. The housing layers 308 and 408 at least partially cover the signal processing layers 306 and 406 and are connected (e.g., fixed) to the frame layers 304 and 404. The housing layers 308 and 408 are made of a metallic material, whereby the housing layers 308 and 408 may improve the anti-electromagnetic interference or electromagnetic compatibility (EMC) performance of the radiation detector modules 30 and 40.

In some embodiments, as shown in FIG. 3 and FIG. 4 in combination with corresponding FIG. 6 and FIG. 8, the housing layers 308 and 408 each are provided with openings 3082 and 4082 for the heat sinks 3062 and 4062 on the signal processing circuit boards 306 and 406 to extend out of the housing layers 308 and 408, so that the heat sinks 3062 and 4062 can dissipate heat better. In addition, the signal processing layers 306 and 406 may include a thermally conductive structure connected to the housings 308 and 408 to more quickly conduct the heat generated by the signal processing layers 306 and 406 to the housings 308 and 408 and away from the housings 308 and 408, so that the signal processing layers 306 and 406 may cool down more quickly. As shown in FIG. 6 and FIG. 8, the heat sinks 3046 and 4046 on the frame layers 304 and 404 may be disposed outside the housing layers 308 and 408 to better dissipate heat.

The radiation detector module of the present disclosure is designed with a layered structure along the ray direction, and the frame at the middle position is configured to play at least one or a plurality of the functions of support, alignment, and heat conduction, so that the radiation detector module is more compact and small in size, and the internal components are accurately aligned, which is easy to assemble and has high reliability. In addition, the radiation detector module of the present disclosure further includes a multi-aspect temperature adjustment design, so that the temperature control of the radiation detector module is more stable.

Some embodiments of the present disclosure may further include a radiation detector apparatus. The radiation detector apparatus includes one or a plurality of radiation detector modules 30 (or 40) according to any one of the embodiments of the present disclosure. In some embodiments, the radiation detector apparatus includes at least two radiation detector modules 30 (or 40). The at least two radiation detector modules 30 (or 40) may be arranged on the same track, such as the arc-shaped track on which the detector array 108 shown in FIG. 2 is mounted.

Some embodiments of the present disclosure may further include a radiation system. The radiation system may include a radiation detector apparatus according to any one of the embodiments of the present disclosure. The radiation system may further include a radiation source. The radiation source is arranged to emit radiation rays toward the radiation detector apparatus. The radiation source may be, for example, the radiation source 104 shown in FIG. 1 or FIG. 2.

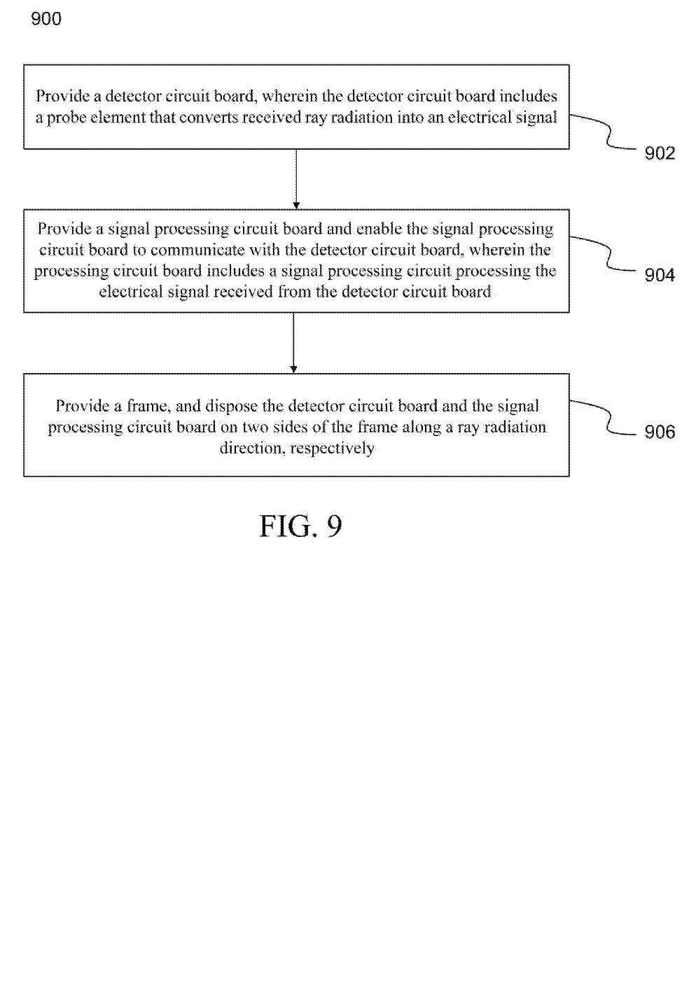

The present disclosure further provides a method for manufacturing a radiation detector. FIG. 9 is a block diagram of a method 900 for manufacturing a radiation detector according to some embodiments of the present disclosure. The method may include a step 902 of providing detector circuit boards 302 and 402, wherein the detector circuit boards 302 and 402 includes a probe element that converts received ray radiation into an electrical signal. The method may include a step 904 of providing signal processing circuit boards 306 and 406, and enabling the signal processing circuit boards 306 and 406 to communicate with the detector circuit boards 302 and 402. The processing circuit boards 306 and 406 each include a signal processing circuit processing the electrical signals received from the detector circuit boards 302 and 402. The method may include a step 906 of providing frames 304 and 404, and disposing the detector circuit boards 302 and 402 and the signal processing circuit boards 306 and 406 on two sides of the frames 304 and 404 along a ray radiation direction, respectively.

The steps described above in combination with FIG. 9 are not intended to limit the order of execution of the method 900. One or a plurality of steps of the method 900 may be performed in a different order according to actual situations. One or a plurality of steps of the method 900 may alternatively be performed in parallel according to actual situations.

In some embodiments, the method 900 may further include enabling the frames 304 and 404 and the detector circuit boards 302 and 402 to perform thermal conduction. In some embodiments, the method 900 may further include covering at least one of the detector circuit boards 302 and 402 and the signal processing circuit boards 306 and 406 in middle regions of the frames 304 and 404. In some embodiments, the method 900 may further include mounting the first heat sinks 3046 and 4046 to an edge region of the frames 304 and 404 extending out of the middle region. In some embodiments, the method 900 may further include disposing a radiation shielding layer between the detector circuit boards 302 and 402 and the frames 304 and 404. In some embodiments, the method 900 may further include disposing heaters 3044 and 4044 between the signal processing circuit boards 306 and 406 and the frames 304 and 404. In some embodiments, the method 900 may further include connecting the detector circuit boards 302 and 402 and the signal processing circuit boards 306 and 406 by using flexible wiring boards 3024 and 4024 to transmit a signal. The wiring boards 3024 and 4024 may be arranged to pass through or across the frames 304 and 404. In some embodiments, the method 900 may further include disposing second heat sinks 3062 and 4062 on the signal processing circuit boards 306 and 406 and extending along the ray radiation direction (the arrow direction shown in FIG. 3 and FIG. 4). In some embodiments, the method 900 may further include providing housings 308 and 408 covering the signal processing circuit boards 306 and 406. The housings 308 and 408 may each include openings 3082 and 4082 for the second heat sinks 3062 and 4062 to extend out of the housings 308 and 408.

Therefore, a person skilled in the art can make appropriate modifications and adjustments to the embodiments described in detail above without departing from the spirit and gist of the present invention. Therefore, it is intended that the claimed subject matter is not limited to only particular examples disclosed, and the claimed subject matter may also include all implementations that fall within the scope of the appended claims and equivalents thereof.

1. A radiation detector module, comprising a stacked multilayer structure, wherein the multilayer structure comprises:
a detector layer, configured to detect a ray that is incident on the detector layer and convert the ray into an electrical signal;
a frame layer, wherein the detector layer is disposed on a first side of the frame layer facing a radiation source and is fixed to the frame layer; and
a signal processing layer, disposed on a second side of the frame layer opposite to the first side and fixed to the frame layer, wherein the signal processing layer is configured to communicate with the detector layer to receive the electrical signal and process the electrical signal.

2. The radiation detector module according to claim 1, wherein the frame layer comprises a thermally conductive material.

3. The radiation detector module according to claim 1, wherein the detector layer, the frame layer, and the signal processing layer each have a flat-plate configuration and are parallel to each other.

4. The radiation detector module according to claim 1, wherein
at least part of a surface of the first side of the frame layer is covered with a radiation shielding layer.

5. The radiation detector module according to claim 1, wherein
a heater is mounted on a surface of the second side of the frame layer, wherein
the surface of the second side of the frame layer comprises a middle region and an edge region outside the middle region, and the heater is mounted in the middle region.

6. The radiation detector module according to claim 5, wherein
at least part of a surface of the heater is covered with a thermal insulation layer, and the thermal insulation layer blocks thermal conduction between the frame layer and the heater.

7. The radiation detector module according to claim 1, wherein
a first heat sink is mounted on a surface of the second side of the frame layer, wherein
the surface of the second side of the frame layer comprises a middle region and an edge region outside the middle region, and the first heat sink is disposed on at least part of the edge region of the surface of the second side.

8. The radiation detector module according to claim 1, wherein
one or a plurality of connecting structures is/are comprised between the signal processing layer and the frame layer, the one or the plurality of connecting structures comprises/comprise one or a plurality of support pillars, gaskets, or supports disposed on the frame layer.

9. The radiation detector module according to claim 1, further comprising a flexible wiring board connecting the detector layer and the signal processing layer to transmit a signal, wherein the wiring board passes through or across the frame layer.

10. The radiation detector module according to claim 1, wherein the signal processing layer comprises a circuit board, and a second heat sink is mounted on the circuit board.

11. The radiation detector module according to claim 1, wherein the multilayer structure further comprises:
a housing layer, at least partially covering the signal processing layer and connected to the frame layer.

12. The radiation detector module according to claim 11, wherein
the signal processing layer comprises a second heat sink, and
the housing layer is provided with an opening for the second heat sink to extend out of the housing layer.

13. A radiation detector apparatus, comprising one or a plurality of radiation detector modules, wherein the radiation detector module comprises:
a detector layer, configured to detect a ray that is incident on the detector layer and convert the ray into an electrical signal;
a frame layer, wherein the detector layer is disposed on a first side of the frame layer and fixed to the frame layer; and
a signal processing layer, disposed on a second side of the frame layer opposite to the first side and fixed to the frame layer, wherein the signal processing layer is configured to communicate with the detector layer to receive the electrical signal and process the electrical signal.

14. The radiation detector apparatus according to claim 13, wherein the radiation detector apparatus comprises at least two radiation detector modules, and the at least two radiation detector modules are arranged on a same track.

15. A radiation detector, comprising:
a detector circuit board, comprising a probe element that converts received ray radiation into an electrical signal;
a signal processing circuit board, communicating with the detector circuit board and comprising a signal processing circuit processing the electrical signal received from the detector circuit board; and
a frame, wherein the detector circuit board and the signal processing circuit board are disposed on two sides of the frame along a ray radiation direction, respectively.

16. The radiation detector according to claim 15, wherein
the frame and the detector circuit board perform thermal conduction.

17. The radiation detector according to claim 16, wherein
the frame comprises a middle region covered by at least one of the detector circuit board and the signal processing circuit board, the frame further comprises an edge region extending out of the middle region, and the frame further comprises a first heat sink mounted to the edge region.

18. The radiation detector according to claim 15, comprising:
a radiation shielding layer, disposed between the detector circuit board and the frame.

19. The radiation detector according to claim 15, comprising:
a heater, disposed between the signal processing circuit board and the frame.

20. The radiation detector according to claim 15, comprising:
a flexible wiring board, connecting the detector circuit board and the signal processing circuit board to transmit a signal, wherein the wiring board passes through or across the frame.
